(19) United States
(12) Patent Application Publication
(10) Pub. No.: US 2006/0203273 A1
(43) Pub. Date: Sep. 14, 2006

(54) Image signal processing method and apparatus

(75) Inventor: Kiyoshi Iwaki, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/078,364

(22) Filed: Mar. 14, 2005

(51) Int. Cl. G06F 3/12

(52) U.S. Cl. 358/1.13; 358/1.15

(57) ABSTRACT

A basic image signal processing method is to enable the setting of a printing image to be checked accurately on the monitor without trial printing of the image. In an image processing method of converting image data from a sender into printing image data, image data is received from the sender and print setting information about the image data is received from the sender. On the basis of the print setting information, the image data received is converted into printing image data. Then, the converted printing image data is returned to a device at the sender. When new print setting information is received, the image data received is converted into printing image data again on the basis of the new print setting information. The converted new printing image data is returned to the device at the sender.

### BACKGROUND OF THE INVENTION

1. Field of the Invention

This invention relates to an image processing method and apparatus, and more particularly to an image processing method and apparatus which enable the state of the colors of a printing image to be set close to the user's favorite.

2. Description of the Related Art

At the present time, when a personal computer (hereinafter, abbreviated as PC) sends image data to a printer, it sends the data via a printer driver. The printer driver enables the user to set the layout and image quality in outputting images, which makes it possible to output the user's favorite images.

In addition, when changing the setting of the image quality on the printer driver, the user can verify on the monitor what the present setting is. On the monitor, the image for verification is shown as a sample image prepared by the printer driver. The user adjusts the colors of the image prepared by the printer driver and sets the hues in printing.

As described above, when the user changes the setting of the printer driver, the state of the setting is reflected in the sample image prepared by the printer driver. The sample image is displayed on the monitor, which enables the user to verify the state of the setting.

However, the verified image on the monitor the user is looking at is just the sample image prepared by the printer driver. Therefore, the image actually output on the printer does not necessarily coincide with the setting screen the user is verifying on the monitor. This means that it is difficult to predict the result of the final output of the image. Actually, the user performs verification, looking at the printed-out image.

### BRIEF SUMMARY OF THE INVENTION

An object of the embodiments is to provide an image signal processing method and apparatus which enable the setting of a printing image to be verified more accurately on the monitor without trial printing of the image. This alleviates the trouble of printing an unintended image and reprinting the intended one.

Furthermore, since the image displayed on the printer driver is a printing image, the user can verify a concrete print image. Being able to verify a printing image beforehand, the user can reduce the possibility of a print failure, which makes the apparatus a user-friendly printing unit.

According to an embodiment of the present invention, there is provided an image processing method of converting image data from a sender into printing image data, the image processing method comprising: receiving image data from the sender; receiving print setting information about the image data from the sender; converting the image data received into printing image data on the basis of the print setting information; returning the converted printing image data to a device at the sender; when receiving new print setting information, converting the image data received into printing image data again on the basis of the new print setting information; and returning the converted new printing image data to the device at the sender.

According to another embodiment of the present invention, there is provided an image processing apparatus which converts image data from a device at a sender into printing image data, the image processing apparatus comprising: means for receiving image data from the sender; means for receiving print setting information about the image data from the sender; means for converting the image data received into printing image data on the basis of the print setting information; means for returning the converted printing image data to a device at the sender; means for, when receiving new print setting information, converting the image data received into printing image data again on the basis of the new print setting information; and means for returning the converted new printing image data to the device at the sender.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram to help explain a state of the connection between a printing unit and a personal computer to which the present invention has been applied;

FIG. 2 is a diagram to help explain an example of the monitor screen on the personal computer side of FIG. 1;

FIG. 3 is a flowchart for the operation procedure to help explain an example of the operation of the apparatus according to the present invention;

FIG. 4 is a flowchart to help explain more concretely an operation executed at the printing unit; and

FIG. 5 is a diagram to help explain more concretely the inside of the image processing section of FIG. 1.

### DETAILED DESCRIPTION OF THE INVENTION

Hereinafter, referring to the accompanying drawings, an embodiment of the present invention will be explained.

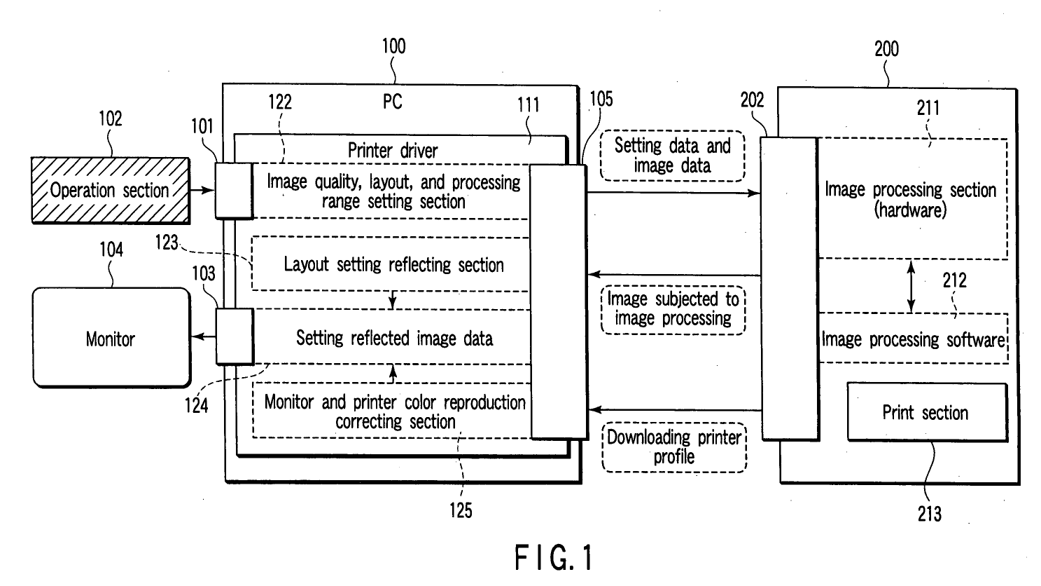

FIG. 1 shows a state of the connection between a printing unit and a personal computer to which the present invention has been applied. Although in FIG. 1, a printing unit 200 functions as an image forming apparatus, a copying machine may be used as the image forming apparatus.

An operation section 102 including a keyboard can be connected via an interface 101 to a personal computer (hereinafter, just referred to as PC) 100. The operation section 102 is assumed to include a mouse. Further to the PC 100, a monitor 104, such as a liquid-crystal display, can be connected via an interface 103.

Still further to the PC 100, for example, the printing unit 200 can be connected via an interface 105.

When printing image data is sent to the printing unit 200, its setting data is also sent. The setting data is created at a printer driver 111 in the PC 100 according to the operation on the operation section 102. The printer driver 111 includes a setting section 122 for performing image-quality setting, layout setting, and processing range setting. It further includes a setting reflecting section 123, a setting reflected image data output section 124, and a monitor and printer color reproduction correcting section 125.

On the other hand, on the basis of the setting data taken in via the interface 202, the printing unit 200 causes an image processing section 211 to process the image data taken in via the interface 202. The taken-in image data is input to, for example, a color converting section in the image processing section 211. The color converting section converts image data into image data C, M, Y, K suitable for printing and outputs the resulting data. The image data C, M, Y, K from the color converting section are subjected to the limitation of the amount of toner adhesion at an amount-of-toner-adhesion limiting circuit. The resulting data are input to a gradating section. The gradated image data C, M, Y, K are output via a printer engine to a print section 213. These image processes are carried out by executing image processing software 212 in harmony with hardware.

Here, in the system, the image data C, M, Y, K subjected to image processing in the printing unit 200 are returned to the PC 100 again.

The PC 100 takes in the returned image data C, M, Y, K and processes the returned image data into the layout state and setting state on the basis of the setting data. These processes are carried out by the setting reflecting section 123.

Furthermore, using the profile information sent from the printing unit 200 and the monitor-side profile information, color conversion of the image data is performed so that the display colors on the monitor side correspond to the colors to be printed out. That is, the returned image data C, M, Y, K are inversely converted into image data R, G, B. This converting process is performed by the monitor and printer color reproduction correcting section 125.

The setting is reflected in the returned image data, which is then corrected in color reproduction. The resulting data is stored temporarily as the setting-reflected image data in the setting-reflected image data output section 124 and is output to the monitor 104.

As a result, looking at the screen of the monitor 104, the user can verify in what state the image data set for printing are to be printed.

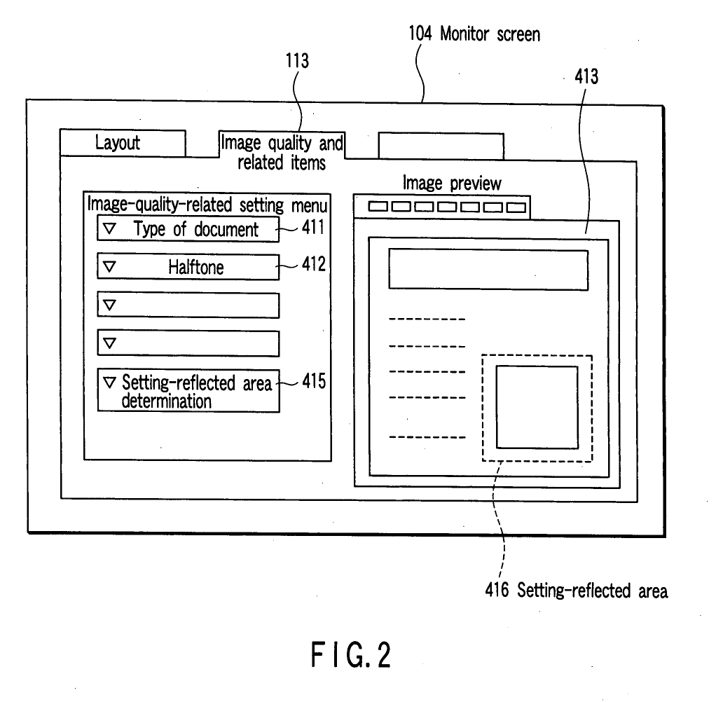

FIG. 2 shows an example of the screen of the monitor 104. On the screen, a monitoring page 401 related to image quality is shown. In this state, item 411 for setting kinds of document to be printed, item 412 for setting halftone, and the like are displayed. In addition, a preview 413 of an image to be printed can be given. When hues or the like are set, its setting-reflected area can be determined. To determine a setting-reflected area, for example, a setting-reflected area determining item 415 is clicked with the cursor. Then, for example, a frame 416 appears. The frame 416 is enlarged, reduced, and moved so as to enclose the desired area, thereby determining a setting-reflected area.

When the setting-reflected area is determined this way, the processing of the printing image data in the printing unit 200 is narrowed down (or limited) to the data in the determined area. As a result, the burden of data processing on the printing unit 200 is alleviated. Specifically, the burden of the changing time (or simulation time), transfer time, and the like of the parameter of the image data is alleviated according to the setting information. Furthermore, when the personal computer 100 converts the data sent back from the printing unit 200 into image data for the monitor, the burden of the processing is also alleviated.

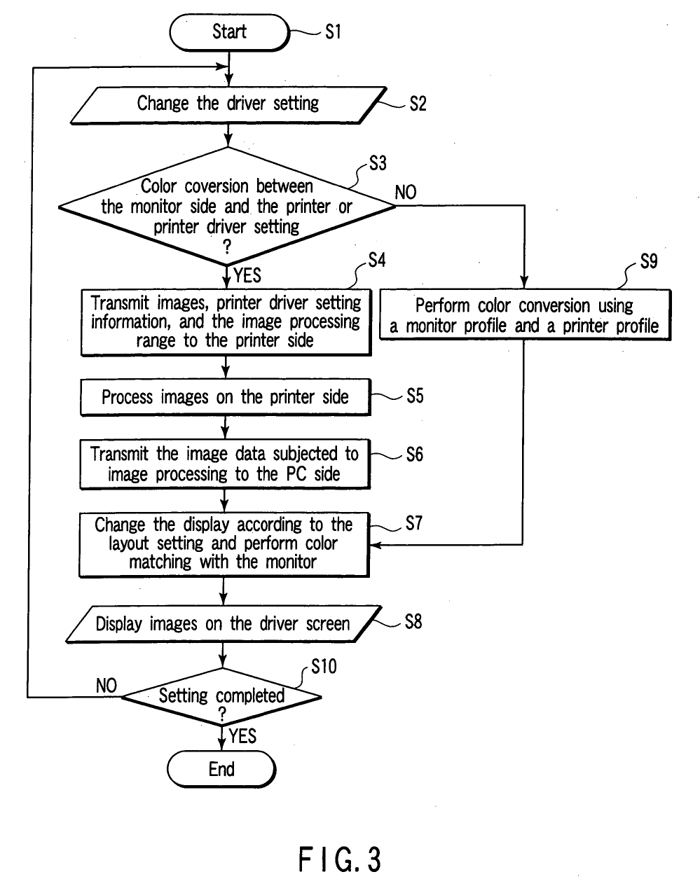

FIG. 3 is a flowchart to help explain the operation of the above-mentioned apparatus. When the personal computer 100 starts to change the driver setting (step S1), a setting screen as shown in FIG. 2 is displayed on the monitor 104. When the user adjusts image quality and related items, looking at the screen of the monitor 104, the user clicks related items, thereby determining the contents of the setting (step S2).

When the driver setting has been changed, the setting information is transmitted by way of step S3 to the printing unit 200 side (step S4). On the printing unit 200 side, the process of converting into printing images on the basis of the setting information is carried out (step S5). Then, the image data after the conversion is stored temporarily and then is sent back to the personal computer side (step S6). The image data from the printing unit 200 is converted into image data for the monitor at the personal computer 100. Moreover, the image data is converted so as to meet the set layout. In addition, the monitor display colors are matched with the colors in printing. The converted image data is reflected in what the result of printing looks like on the screen of the monitor 104 and is displayed there (step S8). Whether the setting has been completed is determined (step S10). If the setting has been completed, the driver setting operation is ended and a print instruction is waited for.

Whether the personal computer 100 has received the profile information from the printing unit 200 is determined in step S3. If the profile information has been received, a color converting process is carried out in step S9, using the monitor-side profile information and the printing unit-side profile information. In the color converting process, conversion is performed in such a manner that the colors of the image printed on the printing unit 200 side are faithfully reproduced on the monitor. Specifically, the CMYK image data on the printing unit 200 side are inversely converted into RGB image data. At this time, since the printing unit carries out a unique adjusting process for printing, such as additional adjustment of black (K) data, further adjustments of hues, sharpness processing, and the like, these adjustment factors are removed or disabled. Then, the RGB image data are converted into image data for the monitor.

As a result, the image displayed on the monitor has an image quality closest to an image to be printed on the printing unit. Therefore, since the actually printed image coincides with the image appearing on the monitor, the user can secure the system reliability and the adjustment reliability.

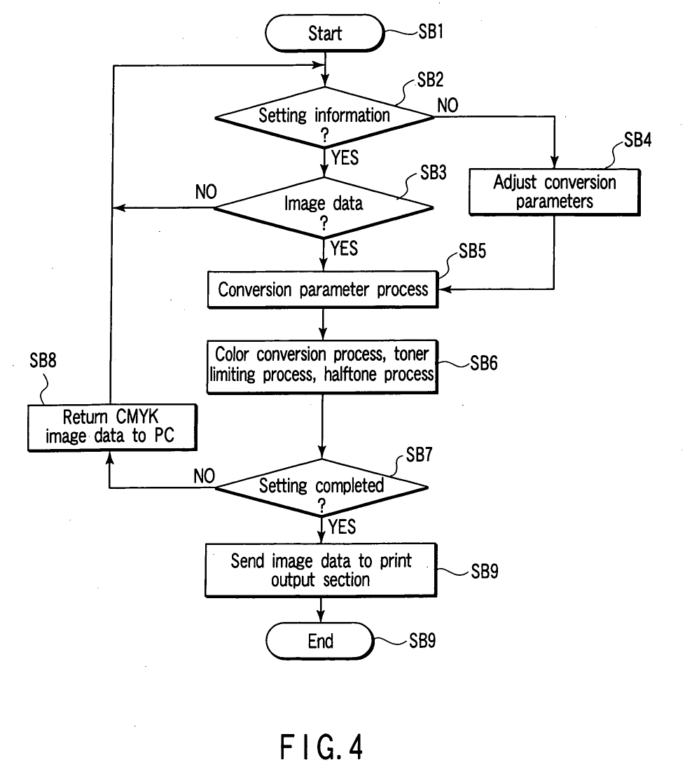

FIG. 4 is a flowchart for an image data process carried out on the printing unit 200 side when the printing unit receives the image data and image-quality setting information from the personal computer 100.

If the taken-in information is the setting information (step SB2), the conversion parameters of the image data are adjusted (step SB4) and stored in a parameter holding section. If the taken-in information is the image data (step SB3), the image data is processed (step SB6) using the conversion parameters (step SB5). In this process, the RGB image data is converted into CMYK image data. In addition, to limit the amount of toner adhesion, the CMYK image data is subjected to the limitation of the amount of toner adhesion and then to a halftone process for printing. Next, in step SB7, it is determined whether the setting has been completed. If the setting has been completed, the image data is sent to a print output section (step SB7) and acts as, for example, a laser beam driving signal for the printer.

If the setting has not been completed in step SB7, the CMYK image data is transferred to the personal computer 100 side.

As described above, with the apparatus and method according to the present invention, the trouble of printing an unintended image and reprinting the intended one is alleviated. Moreover, since the image displayed on the monitor is a printing image, the user can verify a concrete print image. Being able to verify a printing image beforehand, the user can reduce the possibility of a print failure, which makes the apparatus a user-friendly printing unit.

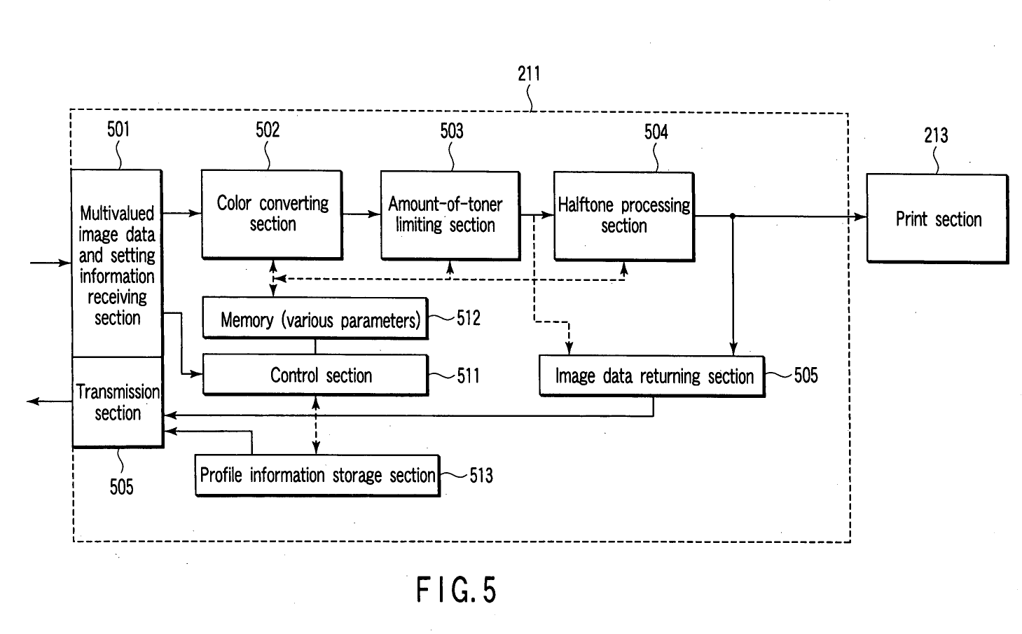

FIG. 5 shows concretely the internal configuration of the image processing section 211 of FIG. 1. The transmission data (image data and print setting information) from the personal computer 100 are received via an interface by a multivalued image data and setting information receiving section 501. Any system may be used as the transmission and reception system. The multivalued image data (RGB image data) are input to a color converting section 502, which converts the data into printing image data (CMYK image data). The color converting section 502 sets a conversion gain or a conversion table according to a parameter from a memory 512. The parameter is selected and changed under the control of a control section 511. The CMYK image data output from the color converting section 502 are subjected to the limitation of the amount of toner adhesion at an amount-of-toner limiting section 503. The limitation of the amount of toner adhesion is a process unique to the printing process. In this process, the image data is converted into the amount of toner adhesion.

At this time, the control section 511 takes in information about the limited amount. The limited amount information is information that indicates how much the image data has been limited. It may be transferred together with profile information to the personal computer 100.

The CMYK image data output from the amount-of-toner limiting section 503 is subjected to data conversion at a halftone processing section 504 so as to obtain gradation in printing. The resulting data is supplied to the print section 213. When a print instruction is given, the print section 213 supplies the image data for each input color to a laser beam output section provided for each color.

The CMYK image data output from the halftone processing section 504 or amount-of-toner limiting section 503 is input to an image data returning section 505. Then, under the control of the control section 511, the CMYK image data is transferred via a transmission section 505 to the microcomputer 100.

Furthermore, the profile information for the printer 211 is transferred via the transmission section 505 to the personal computer 100. In this case, information unique to the printing unit, such as the limited amount information in limiting the amount of toner and the address of the image subjected to the limitation, may be returned. Furthermore, the CMYK image data to be returned may be the output of the amount-of-toner limiting section 503 or the output of the halftone processing section 504.

This invention is not limited to the above embodiments and may be practiced or embodied in still other ways without departing from the spirit or essential character thereof. In addition, various inventions may be configured by suitably combining a plurality of component elements disclosed in the embodiments. For instance, some component elements may be eliminated from all of the component elements shown in each of the embodiments. Furthermore, the component elements related to different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing method of converting image data from a sender into printing image data, the image processing method comprising:
receiving image data from the sender;
receiving print setting information about the image data from the sender;
converting the image data received into printing image data on the basis of the print setting information;
returning the converted printing image data to a device at the sender;
when receiving new print setting information, converting the image data received into printing image data again on the basis of the new print setting information; and
returning the converted new printing image data to the device at the sender.

2. The image processing method according to claim 1, wherein the image data from the sender is either image data of red (R), green (G), and blue (B) or image data of cyan (C), magenta (M), yellow (Y), and black (K), and
the printing image data is image data of cyan (C), magenta (M), yellow (Y), and black (K).

3. The image processing method according to claim 1, wherein the print setting information includes information about the image quality of an image to be printed and about the printing layout.

4. The image processing method according to claim 1, wherein the print setting information includes area specify information that indicates an area where the setting information has to be reflected in an image to be printed, and
the step of converting the image data into printing image data executes the process of, on the basis of the setting information, adjusting the image data in the area specified by the area specify information.

5. The image processing method according to claim 1, wherein the step of returning the new printing image data to the device at the sender is to stop the return when receiving an instruction to end the setting from the device at the sender.

6. An image processing apparatus which converts image data from a device at a sender into printing image data, the image processing apparatus comprising:
means for receiving image data from the sender;
means for receiving print setting information about the image data from the sender;
means for converting the image data received into printing image data on the basis of the print setting information;
means for returning the converted printing image data to a device at the sender;
means for, when receiving new print setting information, converting the image data received into printing image data again on the basis of the new print setting information; and
means for returning the converted new printing image data to the device at the sender.

7. The image processing apparatus according to claim 6, wherein the means for converting the image data received into printing image data on the basis of the print setting information converts image data of red (R), green (G), and blue (B) into image data of cyan (C), magenta (M), yellow (Y), and black (K).

8. The image processing apparatus according to claim 6, wherein the means for converting the image data received into printing image data on the basis of the print setting information converts image data of red (R), green (G), and blue (B) into image data of cyan (C), magenta (M), yellow (Y), and black (K) and further subjects the image data of cyan (C), magenta (M), yellow (Y), and black (K) to the limitation of the amount of toner.

9. The image processing apparatus according to claim 6, wherein
when the print setting information includes area specify information that specifies an area where the setting information has to be reflected in an image to be printed,
the means for converting the image data into printing image data includes means for adjusting, on the basis of the print setting information, only the image data in the area specified by the area specify information.

10. The image processing apparatus according to claim 6, wherein the step of returning the new printing image data to the device at the sender is to stop the return when receiving an instruction to end the setting from the device at the sender.

11. An image processing apparatus comprising:
a device at a sender which includes
means for transmitting image data of red (R), green (G), and blue (B) for printing to a printing unit,
means for transmitting to the printing unit at least image-quality setting information in converting the image data into printing image data of cyan (C), magenta (M), yellow (Y), and black (K),
means for converting the printing image data of cyan (C), magenta (M), yellow (Y), and black (K) returned from the printing unit into display image data of red (R), green (R), and blue (B), and
means for displaying the display image data on a monitor; and
the printing unit which includes
means for receiving the image data of red (R), green (R), and blue (B) sent from the sender,
means for receiving the picture-quality information sent from the sender,
means for converting the image data of red (R), green (R), and blue (B) received into the printing image data of cyan (C), magenta (M), yellow (Y), and black (K) on the basis of the image-quality setting information received,
means for returning the converted printing image data of cyan (C), magenta (M), yellow (Y), and black (K) to the device at the sender,
means for, when receiving new print setting information, converting the image data received into printing image data again on the basis of the new print setting information, and
means for returning the converted new printing image data to the device at the sender.

12. The image processing apparatus according to claim 11, wherein the means for displaying the display image data on a monitor includes means for displaying a frame which encloses an image area where the setting information has been reflected.
